(19) United States
(12) Patent Application Publication
(10) Pub. No.: US 2013/0167430 A1
(43) Pub. Date: Jul. 4, 2013

(54) PROCESS FOR CONVERTING A SOLID BIOMASS MATERIAL

(71) Applicant: SHELL OIL COMPANY, Houston, TX (US)

(72) Inventors: John William HARRIS, Armsterdam (NL); Ye-Mon CHEN, Sugar Land, TX (US)

(73) Assignee: SHELL OIL COMPANY, Houston, TX (US)

(21) Appl. No.: 13/729,227

(22) Filed: Dec. 28, 2012

(30) Foreign Application Priority Data
Dec. 30, 2011 (EP) 11196252.8

(51) Int. Cl. C10L 1/18; B01F 5/00

(52) U.S. Cl. CPC C10L 1/1802; B01F 5/00
USPC 44/307; 137/896; 29/402.01

(57) ABSTRACT

A process for converting a solid biomass material comprising (a) mixing the solid biomass material with a fluid to form a fluidized biomass stream; and (b) propagating the fluidized biomass stream into the riser reactor via one or more delivery aperture(s); wherein the solid biomass material has a particle size distribution with a mean particle size diameter, and wherein the delivery aperture has a diameter equal to or more than three times the mean particle size diameter of the particle size distribution of the solid biomass material.

### CROSS REFERENCE TO RELATED APPLICATIONS

This application claims the benefit of European Patent Application No. 11196252.8, filed on Dec. 30, 2011, the disclosure of which is incorporated by reference herein in its entirety.

### FIELD OF THE INVENTION

Embodiments of the invention relate to a process for converting a solid biomass material.

### BACKGROUND TO THE INVENTION

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of any prior art.

With the diminishing supply of crude mineral oil and fossil fuels in general, use of renewable energy sources is becoming increasingly important for the production of liquid fuels. These fuels from renewable energy sources are often referred to as biofuels.

Biofuels derived from non-edible renewable energy sources, such as cellulosic materials, are preferred as these do not compete with food production. These biofuels are also referred to as second generation biofuels or advanced biofuels. Most of these non-edible renewable energy sources, however, are solid biomass materials that are somewhat cumbersome to convert into liquid fuels.

One process that can be used for converting solid biomass into liquid fuels or other useful chemicals is fluid catalytic cracking (FCC). Recently WO2010/135734 described a method for co-processing a biomass feedstock and a refinery feedstock in a refinery unit comprising catalytically cracking the biomass feedstock and the refinery feedstock in a refinery unit comprising a fluidized reactor, wherein hydrogen is transferred from the refinery feedstock to carbon and oxygen of the biomass feedstock. In one of the embodiments in WO2010/135734, the biomass feedstock comprises a plurality of solid biomass particles having a mean size between 50 and 1000 microns.

In a conventional Fluid Catalytic Cracking Unit (FCCU), such as for example the one shown in U.S. Pat. No. 5,562,818 to Hedrick, finely divided regenerated catalyst is drawn from the regenerator through a regenerator standpipe and contacted with a feedstock in a lower portion of a riser reactor. Feedstock and steam enter the riser reactor through feed nozzles. The mixture of feedstock, steam and regenerated catalyst, passes up through the riser reactor, converting the feedstock into a product while a coke layer deposits on the surface of the catalyst. The product and catalyst obtained from the top of the riser reactor are then passed through cyclones to separate spent catalyst from the product. The spent catalyst enters the stripper where steam is introduced to remove further products from the catalyst. The spent catalyst containing coke then passes through a stripper standpipe to enter the regenerator where, in the presence of air, combustion of the coke layer produces regenerated catalyst and flue gas. The flue gas is separated from entrained catalyst in the upper region of the regenerator by cyclones and the regenerated catalyst is returned to the regenerator fluidized bed. The regenerated catalyst is then drawn from the regenerator fluidized bed through the regenerator standpipe and, in repetition of the previously mentioned cycle, contacts the feedstock in the lower portion of the riser reactor.

One critical element of an FCCU riser reactor design is the feed injection system. For peak performance, it is essential that the feed injection system distributes the feedstock to achieve uniform and dispersed coverage, thereby increasing the surface area of the feedstock in contact with the regenerated catalyst.

For conventional fluid fossil feedstocks a number of prior art feed injection systems have been proposed to ensure effective distribution of the feeds. For example a FCCU can have side entry nozzles or bottom entry nozzles to introduce such a conventional feed into the riser reactor. Bottom entry nozzles introduce the hydrocarbon feed from the bottom of the riser reactor whereas side entry nozzles introduce the feed from the periphery of the riser reactor and at a higher elevation. Modern side entry nozzles, such as disclosed in U.S. Pat. No. 5,794,857 are, in general, good feed atomizers. On the other hand, U.S. Pat. No. 4,097,243, U.S. Pat. No. 4,808,383, U.S. Pat. No. 5,017,343, U.S. Pat. No. 5,108,583, and EP151882 disclose various means to effect and improve feed atomization for bottom entry nozzles.

When trying to convert a solid biomass material in an FCCU, however, such prior art feed injection systems, which were originally designed for fluid fossil feedstocks, may be more prone to wear and contamination and may therefore require more frequent maintenance and/or component replacement. In addition, the use of such prior art feed injection systems for feeding solid biomass material may lead to a suboptimal distribution of the feedstock in the riser reactor.

It would be an advancement in the art to provide a process for converting a solid biomass material in an FCCU that would be more robust and allows for a better feedstock distribution in the riser reactor. It would further be an advancement in the art to provide a method for retrofitting existing FCCU's to allow them to become more robust and to get a better feedstock distribution when converting a solid biomass material.

### SUMMARY OF THE INVENTION

Embodiments of the present invention provide for such a process.

According to a first aspect, there is provided a process for converting a solid biomass material in a riser reactor. The process comprises the steps of (a) mixing a solid biomass material with a fluid to form a fluidized biomass stream, and (b) propagating the fluidized biomass stream into a riser reactor via one or more delivery aperture(s). The solid biomass material has a particle size distribution with a mean particle size diameter, and wherein the delivery aperture has a diameter equal to or more than three times the mean particle size diameter of the particle size distribution of the solid biomass material.

It has been found that such a diameter of the delivery aperture for feeding solid biomass material into the riser reactor ensures a better feed consistency. In addition the use of such a delivery aperture minimizes the potential for clogging of the delivery aperture.

According to a second aspect, there is provided a process for converting a solid biomass material. The process comprises feeding a solid biomass material into a riser reactor via one or more delivery aperture(s), where the solid biomass material has a particle size distribution with a mean particle size diameter, and wherein the delivery aperture has a diameter equal to or more than three times the mean particle size diameter of the particle size distribution of the solid biomass material. The process further comprises contacting the solid biomass material, and optionally a hydrocarbon-cofeed, with a catalytic cracking catalyst at a temperature of equal to or more than 400° C. in the riser reactor to produce one or more products.

According to a third aspect of the invention, there is provided a method for retrofitting an existing fluidized catalytic cracking unit comprising a riser reactor to make the fluidized catalytic cracking unit suitable for converting a solid biomass material. The method comprises replacing one or more existing feedstock distributors comprising delivery apertures having a first diameter with one or more new feedstock distributors comprising delivery apertures having a second diameter. The second diameter is larger than the first diameter and wherein the second diameter is equal to or more than three times the mean particle size diameter of the particle size distribution of the solid biomass material.

It will be appreciated by the person skilled in the art that the preferences described herein below in the first aspect of the invention, may also apply in the second aspect and/or in the third aspect of the invention. For example the preferences given below in the first aspect for the particle size diameter may also apply in the second and/or third aspect; and the preferences as described for the diameter of the delivery aperture in the first aspect may also apply to the diameter of the delivery aperture in the second aspect and/or to the second diameter in the third aspect of the invention.

It will further be appreciated by the person skilled in the art that the principle of the invention, whilst particularly applicable to the delivery aperture, is also relevant to delivery channels or the like for transporting the fluidized biomass stream. The process according to aspects of the invention may hence preferably also comprise passing the fluidized biomass stream to the delivery aperture via a delivery channel, the delivery channel having a minimum diameter equal to or more than three times the mean particle size diameter of particle size distribution of the solid biomass material. Preferred minimum diameters of the delivery channel may be as described in respect of the diameter of the delivery aperture.

Other features of embodiments of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### DRAWINGS

The aspects of the invention will be illustrated by the following non-limiting illustrations:

FIG. 1 shows an exemplary embodiment according to aspects of the invention.

### DETAILED DESCRIPTION OF PREFERRED EMBODIMENTS OF THE INVENTION

According to one aspect, embodiments of the invention involve step (a) of mixing a solid biomass material with a fluid to form a fluidized biomass stream, and step (b) of propagating the fluidized biomass stream into a riser reactor via one or more delivery aperture(s). These steps may be referred to as “step (a)” and “step (b),” respectively.

By a biomass material is herein understood a composition of matter of biological origin as opposed to a composition of matter obtained or derived from petroleum, natural gas or coal. Without wishing to be bound by any kind of theory it is believed that such biomass material will contain carbon-14 isotope in an abundance of at least about 0.0000000001%, based on total moles of carbon.

By a solid biomass material is herein understood a biomass material that is at least partly in a solid state at a temperature of about 20° C. and a pressure of about 0.1 MPa (MegaPascal). The solid biomass material may suitably be present as solid biomass material particles. These “solid biomass material particles” are herein also referred to as “solid biomass particles.”

Any solid biomass material known to the person skilled in the art may be used in the process of the invention. In a preferred embodiment, the solid biomass material is not a material used for human food production. Examples of preferred solid biomass materials include aquatic plants and algae, agricultural waste and/or forestry waste and/or paper waste and/or plant material obtained from domestic waste.

Preferably, the solid biomass material is a solid cellulosic material. The term “cellulosic material” is understood to refer to a material comprising cellulose, hemicellulose, lignocellulose and/or lignin. Examples of suitable cellulosic materials include agricultural wastes such as corn stover, soybean stover, corn cobs, rice straw, rice hulls, oat hulls, corn fibre, cereal straws such as wheat, barley, rye and oat straw; grasses; forestry products and/or forestry residues such as wood and wood-related materials such as sawdust; waste paper; sugar processing residues such as bagasse and beet pulp; or mixtures thereof.

In a preferred embodiment, the solid biomass material is selected from the group consisting of wood, sawdust, straw, grass, bagasse, corn stover, and any combination thereof.

The solid biomass material may have undergone drying, torrefaction, particle size reduction, densification and/or pelletization before being mixed with the fluid, to allow for improved process operability and economics.

In one embodiment, when the solid biomass is dried, the solid biomass material is dried until the solid biomass material has a moisture content in the range of equal to or more than about 0.1 wt % to equal to or less than about 25 wt %, more preferably in the range of equal to or more than about 5 wt % to equal to or less than about 20 wt %, and most preferably in the range of equal to or more than about 10 wt % to equal to or less than about 15 wt %. In one embodiment, moisture content can be determined via ASTM E1756-01 Standard Test method for Determination of Total solids in Biomass. In this method, the loss of weight during drying is a measure for the original moisture content.

In a preferred embodiment, the solid biomass material is torrefied to form a torrefied solid biomass material. Preferably, such torrefied solid biomass material is used to be mixed with the fluid in step a). In a further preferred embodiment, the process according to aspects of the invention comprises a step of torrefying the solid biomass material at a temperature of equal to or more than about 200° C. to produce a torrefied solid biomass material whereafter the torrefied solid biomass material is mixed with the fluid in step (a).

By torrefying or torrefaction is herein understood the treatment of the solid biomass material at a temperature in the range from equal to or more than about 200° C. to equal to or less than about 350° C. in the essential absence of a catalyst and in an oxygen-poor, preferably an oxygen-free, atmosphere. By an oxygen-poor atmosphere is understood an atmosphere containing equal to or less than about 15 vol. % oxygen, preferably equal to or less than about 10 vol. % oxygen and more preferably equal to or less than about 5 vol. % oxygen. By an oxygen-free atmosphere is understood that the torrefaction is carried out in the essential absence of oxygen.

Torrefying of the solid biomass material is preferably carried out at a temperature of more than about 200° C., more preferably at a temperature equal to or more than about 210° C., still more preferably at a temperature equal to or more than about 220° C., yet more preferably at a temperature equal to or more than about 230° C. In addition torrefying of the solid biomass material is preferably carried out at a temperature less than about 350° C., more preferably at a temperature equal to or less than about 330° C., still more preferably at a temperature equal to or less than about 310° C., yet more preferably at a temperature equal to or less than about 300° C.

Torrefaction of the solid biomass material is preferably carried out in the essential absence of oxygen. More preferably the torrefaction is carried under an inert atmosphere, containing for example inert gases such as nitrogen, carbon dioxide and/or steam; and/or under a reducing atmosphere in the presence of a reducing gas such as hydrogen, gaseous hydrocarbons such as methane and ethane or carbon monoxide.

The torrefying step may be carried out at a wide range of pressures. In a preferred embodiment, the torrefying step is carried out at atmospheric pressure (about 0.1 MPa).

During torrefaction of the solid biomass material torrefaction gases can be produced. These torrefaction gases can contain carbon monoxide and carbon dioxide but also volatile fuels such as for example methane, ethane, ethene and/or methanol. In one embodiment, one or more of these torrefaction gases are retrieved and used as a fluid.

In a preferred embodiment, the solid biomass material is a micronized solid biomass material. The term “micronized solid biomass material” is understood to refer to a solid biomass material that has a particle size distribution with a mean particle size diameter in the range from equal to or more than 5 micrometer to equal to or less than 5000 micrometer, as measured with a laser scattering particle size distribution analyzer. In a preferred embodiment, the process according to aspects of the invention comprises a step of reducing the particle size of the solid biomass material, optionally before or after such solid biomass material is torrefied. Such a particle size reduction step may for example be especially advantageous when the solid biomass material comprises wood or torrefied wood. The particle size of the optionally torrefied solid biomass material can be reduced in any manner known to the skilled person to be suitable for this purpose. Suitable methods for particle size reduction include crushing, grinding and/or milling. The particle size reduction may, for example, be achieved by means of a ball mill, hammer mill, (knife) shredder, chipper, knife grid, or cutter.

In a preferred embodiment, the solid biomass material has a particle size distribution where the mean particle size diameter lies in the range from equal to or more than 5 micrometer (micron), more preferably equal to or more than 10 micrometer, even more preferably equal to or more than 20 micrometer, and most preferably equal to or more than 100 micrometer to equal to or less than 5000 micrometer, more preferably equal to or less than 1000 micrometer and most preferably equal to or less than 500 micrometer.

The term “particle size diameter” may herein also be referred to as “particle diameter,” and the term “mean particle size diameter” may herein also be referred to as “mean particle diameter.”

In a particularly preferred embodiment, the solid biomass material has a particle size distribution where the mean particle size diameter is equal to or more than about 100 micrometer to avoid blocking of pipelines and/or nozzles. Most preferably the solid biomass material has a particle size distribution where the mean particle size diameter is equal to or less than about 3000 micrometer to allow easy injection into the riser reactor.

In one embodiment, the particle size distribution and mean particle size diameter of the solid biomass material can be determined with a Laser Scattering Particle Size Distribution Analyzer, preferably a Horiba LA950, according to the ISO 13320 method titled “Particle size analysis—Laser diffraction methods.”

Hence, in a preferred embodiment, the process according to aspects of the invention comprises a step of reducing the particle size of the solid biomass material, optionally before and/or after torrefaction, to generate a particle size distribution having a mean particle size diameter in the range from equal to or more than about 5, more preferably equal to or more than about 10 micron, and most preferably equal to or more than about 20 micron, to equal to or less than about 5000 micron, more preferably equal to or less than about 1000 micrometer and most preferably equal to or less than about 500 micrometer to produce a micronized, optionally torrefied, solid biomass material.

The solid biomass material may comprise particles that are not round. In certain embodiments, the solid biomass material may even comprise essentially irregular-shaped particles. In a preferred embodiment, the mean particle size diameter is a mean maximum particle size diameter. That is, preferably the solid biomass material may have a particle size distribution with a mean maximum particle size diameter and the delivery aperture has a diameter equal to or more than three times this mean maximum particle size diameter. The term “maximum particle size diameter” refers at least to the largest diameter that can be measured within a certain particle. Without wishing to be bound by any kind of theory, it is believed that when a solid biomass material particle, especially an irregular shaped solid biomass material particle, is spinning around fast around its center, the particle may occupy an imaginary spherical space. The non-round or irregular shaped solid biomass particle may therefore act in the process as a spherical particle having a diameter of the same size as the above maximum particle size diameter.

The term “maximum particle size diameter” may herein also be referred to as “maximum particle diameter,” and the term “mean maximum particle size diameter” may herein also be referred to as “mean maximum particle diameter.” For example, if the solid biomass material comprises a plurality of essentially cylindrical shaped particles, which cylindrical shaped particles each have a longitudinal diameter and a cross-sectional diameter, which longitudinal diameter is larger than the cross-sectional diameter; the maximum particle size diameter may be the longitudinal diameter. The term “longitudinal diameter” is herein preferably understood the maximum diameter of an essentially cylindrically shaped particle in a direction parallel or equal to its longitudinal axis. The term “cross-sectional diameter” is herein preferably understood the maximum diameter of a cross-section of the cylindrically-shaped particle in a direction perpendicular to its longitudinal axis.

In a preferred embodiment, the solid biomass material may have a particle size distribution with about 70-vol %, 90-vol % or 99-vol % maximum particle size diameter and the delivery aperture has a diameter equal to or more than three times this 70-vol %, 90-vol % or 99-vol % maximum particle size diameter. The 70-vol %, 90-vol % or 99-vol % maximum particle size diameter may suitably be determined by measuring the volumetric particle size distribution of the maximum particle size diameter (that is, for each particle size distribution the volume of particles having such maximum particle size diameter or a smaller maximum particle size diameter may be determined).

By a respectively 70-vol %, 90-vol % or 99-vol % maximum particle size diameter is herein understood a diameter where respectively 70 volume %, 90 volume % or 99 volume % of the solid biomass material particles has a maximum particle size diameter equal to or smaller than that.

In a further preferred embodiment, the delivery aperture may have a diameter equal to or more than four times, or even equal to or more than five times, the respective mean particle size diameter, mean maximum particle size diameter, or 70-vol %, 90-vol % or 99-vol % maximum particle size diameter as describe herein above.

The term “delivery aperture” refers to an opening through which the solid biomass material is delivered into the riser reactor. The opening may have any shape known to the skilled person in the art to be suitable for delivering a feedstock into a riser reactor. For example the opening may have an essentially square, an essentially rectangular, an essentially circular, or an essentially elliptical shape. In a preferred embodiment, the opening has an essentially circular shape or an essentially rectangular shape. If the opening has an essentially rectangular shape it is sometimes also referred to as a slit. The diameter of the delivery aperture is the shortest diameter measurable in cross section.

In one embodiment, the diameter of the delivery aperture is selected based on the mean particle diameter of the solid biomass material. For example, the delivery aperture may have a diameter of equal to or more than about 0.015 millimeter (mm), or equal to or more than about 0.15 mm, or equal to or more than about 0.45 mm, or equal to or more than about 0.90 mm or equal to or more than about 1.8 mm or equal to or more than about 2.4 mm or equal to or more than about 3 mm, or equal to or more than about 5 mm, or equal to or more than about 10 mm or equal to or more than about 15 mm. For practical purposes, in some embodiments, the delivery aperture may for example have a diameter of equal to or less about 100 mm, or equal to or less than about 50 mm, or equal to or less than about 30 mm or equal to or less than about 15 mm, or equal to or less than about 10 mm, or equal to or less than about 6 mm, or equal to or less than about 3 mm.

The delivery aperture may be situated in a feed nozzle and/or supported on or defined by a distributor. In one embodiment, one or more distribution apertures may be used. These one or more distribution apertures may conveniently be situated in one or more feed nozzles and/or supported on or defined by one or more distributors.

In a preferred embodiment, the process according to aspects of the invention comprises propagating the fluidized biomass stream into the riser reactor via a plurality of delivery apertures each delivery apertures having a minimum diameter equal to more than about three times the mean particle size diameter of the particle size distribution of the solid biomass material. In a particular embodiment, the plurality of delivery apertures is arranged in one or more arrays, for example annular arrays, which arrays may optionally be concentric.

In one embodiment, one or more delivery apertures are situated in or supported on or defined by a ring-shaped distributor, comprising a ring-shaped pipe with one or more delivery apertures located in the pipe. Such a distributor is also referred to as annular distributor.

When a distributor comprises more than one delivery aperture, the distributor preferably comprises in the range from equal to or more than 2 delivery apertures, more preferably equal to or more than 6 delivery apertures to equal to or less than about 100000 delivery apertures.

The delivery apertures may conveniently be located in a feed nozzle.

In a preferred embodiment, such a feed nozzle is a so-called two channel feed nozzle. Such a feed nozzle preferably comprises an inner tube defining a fluid conduit and an outer tube arranged around the inner tube, wherein the outer surface of the inner tube and the inner surface of the outer tube define an annular conduit for the solid biomass material, and wherein each of the tubes have an inlet end and an outlet end. Such a feed nozzle may take a variety of forms, including the forms as disclosed or referenced in WO0118153, U.S. Pat. No. 5,794,857, U.S. Pat. No. 4,097,243, U.S. Pat. No. 4,808,383, U.S. Pat. No. 5,017,343, U.S. Pat. No. 5,108,583, and EP151882.

In one embodiment, the feed nozzle may be an internal mix feed nozzle (where the fluid and solid biomass material are mixed within the nozzle) or an external mix feed nozzle (where the fluid and solid biomass material are mixed outside the nozzle). In a preferred embodiment, the feed nozzle is an internal mix feed nozzle.

The location of the delivery aperture may depend on the specific form of the distributor and/or feed nozzle used.

The fluid used in step (a) can be a gas or a liquid. In a preferred embodiment, the fluid is a gas.

In one embodiment, the fluid is selected from the group consisting of steam, vaporized liquefied petroleum gas, gasoline, diesel, kerosene, naphtha, methane, hydrogen sulphide, hydrogen, and any combination thereof.

In another embodiment, the fluid may comprise a liquid or gaseous hydrocarbon co-feed as described herein below.

The fluid mixed with the solid biomass material may be a lift gas. Examples of such a liftgas include steam, vaporized oil and/or oil fractions, and any combination thereof. In a preferred embodiment, steam is the lift gas. However, the use of a vaporized oil and/or oil fraction (preferably vaporized liquefied petroleum gas, gasoline, diesel, kerosene or naphtha) as a liftgas may have the advantage that the liftgas can simultaneously act as a hydrogen donor and may prevent or reduce coke formation. In an especially preferred embodiment, both steam and vaporized oil and/or a vaporized oil fraction (preferably liquefied petroleum gas, vaporized gasoline, diesel, kerosene or naphtha) are used as a liftgas, optionally the steam and vaporized oil and/or vaporized oil fraction are mixed together in a liftgas mixture.

In one embodiment, the solid biomass material is mixed with the lift gas or liftgas mixture before entry in the riser reactor. If the solid biomass material is not mixed with a liftgas prior to entry into the riser reactor it may be fed simultaneously with the liftgas (at one and the same location) to the riser reactor, and optionally mixed upon entry of the riser reactor in a feed nozzle; or it may be fed separately from any liftgas (at different locations) to the riser reactor.

The solid biomass material to fluid weight ratio is preferably in the range from equal to or more than 0.01:1, more preferably equal to or more than 0.05:1 to equal to or less than 5:1, more preferably equal to or less than 1.5:1.

When both the solid biomass material and the liftgas are introduced into the bottom of the riser reactor, the liftgas-to-solid biomass material weight ratio is preferably in the range from equal to or more than 0.01:1, more preferably equal to or more than 0.05:1 to equal to or less than 5:1, more preferably equal to or less than 1.5:1.

In a preferred embodiment, the fluidised biomass stream may be propagated into the reactor under a pressure in the range of from equal to or more than about 0.05 to equal to or less than 0.5 MegaPascal (MPa), more preferable from equal to or more than about 0.1 to equal to or less than 0.4 MPa, most preferably from equal to or more than about 0.2 to equal to or less than 0.3 MPa.

In another preferred embodiment, the fluidised biomass stream may be propagated into the reactor with a velocity in the range from equal to or more than about 10 meter/second, more preferably from equal to or more than about 20 meter/second, most preferably from equal to or more than about 30 meter/second to equal to or less than about 200 meter/second, more preferably to equal to or less than about 150 meter/second and most preferably to equal to or less than about 100 meter/second.

The diameter of the delivery aperture has a significant impact on biomass delivery velocities. To ensure suitable delivery velocities without the need for excessive pressure, in one embodiment, each or a plurality of delivery aperture(s) may advantageously have a maximum diameter equal to at most ten times the mean particle diameter of the particle size distribution of the solid biomass material.

The term “riser reactor” is understood to refer to an elongated tube-like reactor, for example suitable for carrying out catalytic cracking reactions. The elongated tube-like reactor is preferably oriented in an essentially vertical manner. In a preferred embodiment, the riser reactor is part of a catalytic cracking unit (i.e. as a catalytic cracking reactor), more preferably a fluidized catalytic cracking (FCC) unit.

Examples of suitable riser reactors are described in the Handbook titled “Fluid Catalytic Cracking technology and operations”, by Joseph W. Wilson, published by PennWell Publishing Company (1997), chapter 3, especially pages 101 to 112, which is herein incorporated by reference.

The riser reactor may be a so-called internal riser reactor or a so-called external riser reactor as described therein.

In a preferred embodiment, the solid biomass material is introduced at the bottom part of the riser reactor. It may further be advantageous to increase the residence time of the solid biomass material at that part of the riser reactor by increasing the diameter of the riser reactor at the bottom. Hence in a preferred embodiment the riser reactor comprises a riser reactor pipe and a bottom section, which bottom section has a larger diameter than the riser reactor pipe, and wherein a solid biomass material is supplied to the riser reactor in the bottom section.

In another preferred embodiment, the total average residence time of the solid biomass material in the riser reactor lies in the range from equal to or more than about 1.0 seconds, more preferably from equal to or more than about 1.5 seconds, still more preferably from equal to or more than about 2.0 seconds to equal to or less than about 5.0 seconds, preferably to equal to or less than about 4.0 seconds, most preferably to equal to or less than about 2.5 seconds. Residence time is based at least on the vapour residence at outlet conditions, that is, residence time includes not only the residence time of a specified feed (such as for example a solid biomass material) but also the residence time of its conversion products.

In a second aspect of the invention, there is provided a process for converting a solid biomass material, the process comprising feeding the solid biomass material into a riser reactor via one or more delivery aperture(s). The solid biomass material has a particle size distribution with a mean particle size diameter, and wherein the delivery aperture has a diameter equal to or more than three times the mean particle size diameter of the particle size distribution of the solid biomass material. The process further comprises contacting the solid biomass material, and optionally a hydrocarbon-co-feed, with a catalytic cracking catalyst at a temperature of equal to or more than about 400° C. in the riser reactor to produce one or more products.

For this second aspect of the invention the preferences for the solid biomass material, the delivery aperture and any distributors and feed nozzles and the riser reactor are as described above.

In a preferred embodiment, the temperature in the riser reactor, where the solid biomass material is contacted with the catalytic cracking catalyst, lies in the range from equal to or more than about 400° C., more preferably from equal to or more than about 450° C., still more preferably from equal to or more than about 480° C., to equal to or less than about 800° C., more preferably to equal to or less than about 700° C., still more preferably to equal to or less than about 600° C. and most preferably to equal to or less than about 550° C.

In a preferred embodiment, the pressure in the riser reactor ranges from equal to or more than about 0.05 MPa to equal to or less than about 1 MPa, more preferably from equal to or more than about 0.1 MPa to equal to or less than about 0.6 MPa.

The weight ratio of catalytic cracking catalyst to total feedstock (that is the total feedstock of solid biomass material and any hydrocarbon co-feed) will herein also be referred to as catalyst to feed ratio (catalyst:feed ratio). This catalyst to feed weight ratio preferably lies in the range from equal to or more than about 1:1, more preferably from equal to or more than about 2:1 and most preferably from equal to or more than about 3:1 to equal to or less than about 150:1, more preferably to equal to or less than about 100:1, most preferably to equal to or less than about 50:1.

Optionally, also a hydrocarbon co-feed is contacted with the catalytic cracking catalyst in the riser reactor.

The solid biomass material may for example be supplied to the riser reactor at a location upstream of a location where the hydrocarbon co-feed is supplied to the riser reactor. The hydrocarbon co-feed can be used as the fluid to form the fluidised biomass stream.

The hydrocarbon co-feed (herein also referred to as hydrocarbon feed) comprises one or more material(s) other than the solid biomass material described above. The term “hydrocarbon feed” refers to a feed that contains one or more hydrocarbon compounds. A hydrocarbon compound is herein understood a compound that contains both hydrogen and carbon and preferably consists of hydrogen and carbon. In a preferred embodiment, the hydrocarbon co-feed is a fluid hydrocarbon co-feed. A fluid hydrocarbon co-feed is herein understood a hydrocarbon co-feed that is not in a solid state when contacted with the FCC catalyst. The hydrocarbon co-feed is preferably fed via a feed nozzle into the riser reactor in an essentially liquid state, in an essentially gaseous state or in a partially liquid-partially gaseous state. For hydrocarbon co-feeds that are highly viscous, it may therefore be advantageous to preheat such feeds before entering the feed nozzle. The hydrocarbon co-feed is preferably in a gaseous state when contacted with the catalytic cracking catalyst. When entering the riser reactor in an essentially or partially liquid state, the fluid hydrocarbon co-feed preferably vaporizes upon entry and preferably is contacted in a gaseous state with the catalytic cracking catalyst and/or the solid biomass material.

The hydrocarbon co-feed can for example be any non-solid hydrocarbon co-feed known to the skilled person to be suitable as a feed for a catalytic cracking unit. The hydrocarbon co-feed can for example be obtained from a conventional crude oil (also sometimes referred to as a petroleum oil or mineral oil), an unconventional crude oil (that is, oil produced or extracted using techniques other than the traditional oil well method) or a Fischer Tropsch oil (sometimes referred to as a synthetic oil) and any combination thereof.

The hydrocarbon co-feed may also be a hydrocarbon co-feed from a renewable source, such as for example a vegetable oil.

In one embodiment, the hydrocarbon co-feed is derived from a crude oil. In a preferred embodiment, the crude oil is conventional. Examples of conventional crude oils include West Texas Intermediate crude oil, Brent crude oil, Dubai-Oman crude oil, Arabian Light crude oil, Midway Sunset crude oil or Tapis crude oil. Such oils are sometimes also referred to as mineral oils and preferably the hydrocarbon co-feed is therefore a mineral hydrocarbon co-feed. A mineral hydrocarbon co-feed is understood a hydrocarbon co-feed that comprises or is derived from a mineral oil.

In another preferred embodiment, the hydrocarbon co-feed comprises a fraction of a, preferably conventional, crude oil or renewable oil. Preferred hydrocarbon co-feeds include straight run (atmospheric) gas oils, flashed distillate, vacuum gas oils (VGO), coker gas oils, diesel, gasoline, kerosene, naphtha, liquefied petroleum gases, atmospheric residue (“long residue”) and vacuum residue (“short residue”) and/or mixtures thereof. Most preferably the hydrocarbon co-feed comprises a long residue and/or VGO.

The composition of the hydrocarbon co-feed may vary widely. The hydrocarbon co-feed may for example contain paraffins, olefins and aromatics. By paraffins, both normal-, cyclo- and branched-paraffins are understood.

In a preferred embodiment, the hydrocarbon co-feed comprises one or more paraffins, for example in the range from equal to or more than about 20 wt % to equal to or less than about 100 wt % paraffins, preferably in the range from equal to or more than about 50 wt % of paraffins, more preferably from equal to or more than about 70 wt % of paraffins, most preferably from equal to or more than about 90 wt %, to equal to or less than about 100 wt %, based on the total weight of the hydrocarbon co-feed. Such a hydrocarbon co-feed comprising one or more paraffins is herein also referred to as a paraffinic hydrocarbon co-feed.

For practical purposes the paraffin content of all hydrocarbon co-feeds having an initial boiling point of at least about 260° C. can be measured by means of ASTM method D2007-03 titled “Standard test method for characteristic groups in rubber extender and processing oils and other petroleum-derived oils by clay-gel absorption chromatographic method”, wherein the amount of saturates will be representative for the paraffin content. For all other hydrocarbon co-feeds the paraffin content of the hydrocarbon co-feed can be measured by means of comprehensive multi-dimensional gas chromatography (GCxGC), as described in P. J. Schoenmakers, J. L. M. M. Oomen, J. Blomberg, W. Genuit, G. van Velzen, J. Chromatogr. A, 892 (2000) p. 29.

Examples of paraffinic hydrocarbon co-feeds include sFischer-Tropsch derived hydrocarbon streams, such as that described in WO2007/090884, which is incorporated by reference, or a hydrotreater product or hydrowax. By hydrowax is understood the bottoms fraction of a hydrocracker. Examples of hydrocracking processes are described in EP699225, EP649896, WO97/18278, EP705321, EP994173 and U.S. Pat. No. 4,851,109, the disclosures of which are herein incorporated by reference. Hydrocracking processes may yield a bottoms fraction that can be used as hydrocarbon co-feed.

In a preferred embodiment, the hydrocarbon co-feed comprises equal to or more than about 11 wt % elemental hydrogen, more preferably more than about 12 wt % elemental hydrogen (i.e. hydrogen atoms), based on the total hydrocarbon co-feed on a dry basis (i.e. water-free basis). A high content of elemental hydrogen, such as a content of equal to or more than about 12.2 wt %, allows the hydrocarbon co-feed to act as a cheap hydrogen donor in the catalytic cracking process. A particularly preferred hydrocarbon co-feed having an elemental hydrogen content of equal to or more than about 12.5 wt % is Fischer-Tropsch derived waxy raffinate. Such Fischer-Tropsch derived waxy raffinate may for example comprise about 85 wt % of elemental carbon and about 15 wt % of elemental hydrogen.

The weight ratio of the solid biomass material to hydrocarbon co-feed may vary widely.

The weight ratio of hydrocarbon co-feed to solid biomass material is preferably equal to or more than about 50 to 50 (5:5), more preferably equal to or more than about 70 to 30 (7:3), still more preferably equal to or more than about 80 to 20 (8:2), even still more preferably equal to or more than about 90 to 10 (9:1). In one embodiment, the weight ratio of hydrocarbon co-feed to solid biomass material is preferably equal to or less than about 99.9 to 0.1 (99.9:0.1), more preferably equal to or less than about 95 to 5 (95:5). The hydrocarbon co-feed and the solid biomass material are preferably being fed to the catalytic cracking reactor in a weight ratio within the above ranges.

The catalytic cracking catalyst is preferably a fluidized catalytic cracking (FCC) catalyst. The fluidized catalytic cracking (FCC) catalyst preferably comprises a zeolite (also sometimes referred to as a crystalline aluminosilicate), preferably dispersed in an amorphous matrix component. In addition, the FCC catalyst preferably comprises a binder and/or a filler.

In a preferred embodiment, the FCC catalyst includes a so-called “large pore” zeolite. A “large pore” zeolite is herein understood a zeolite comprising a porous, crystalline aluminosilicate structure having a porous internal cell structure on which the major axis of the pores is in the range of about 0.62 nanometer to about 0.8 nanometer. The axes of zeolites are depicted in the ‘Atlas of Zeolite Structure Types’, of W. M. Meier, D. H. Olson, and Ch. Baerlocher, Fourth Revised Edition 1996, Elsevier, ISBN 0-444-10015-6. Examples of such large pore zeolites include FAU or fauj asite.

In a preferred embodiment, the FCC catalyst includes a zeolite chosen from the group consisting of Y zeolites; ultrastable Y zeolites (USY); X zeolites, zeolite beta, zeolite L, offretite, mordenite, faujasite (including synthetic faujasite), zeolite omega, Rare Earth zeolite Y (=REY), Rare Earth USY (REUSY), and any combination thereof.

If the FCC catalyst comprises a Y-type zeolite, such a Y-type zeolite preferably comprises an overall silica-to-alumina mole ratio of more than about 3.0, and more preferably, an overall silica-to alumina mole ratio of between about 3.0 and about 6.0.

Such FCC catalyst can also comprise a medium pore zeolite in addition to the above mentioned zeolites. A “medium pore” zeolite is herein understood a zeolite comprising a porous, crystalline aluminosilicate structure having a porous internal cell structure on which the major axis of the pores is in the range of about 0.45 nanometer to about 0.62 nanometer.

Hence, in addition to the above mentioned zeolites, the FCC catalyst preferably includes a zeolite chosen from the group consisting of MFI type zeolites (such as for example ZSM-5); MTW type zeolites (such as for example ZSM-12); MTT type zeolites (such as for example ZSM-23;) the TON type zeolites (such as for example zeolite theta one or ZSM-22); and the FER structural type, for example, ferrierite. Of these MFI type zeolites, preferably ZSM-5, are most preferred.

In a preferred embodiment, the FCC catalyst comprises zeolite Y or ultrastable zeolite Y (USY) in combination with an MFI type zeolite such as ZSM-5.

If the FCC catalyst comprises both a large pore zeolite and a medium pore zeolite, the ratio of the large pore zeolite to the medium pore size zeolite in the FCC catalyst is preferably in the range of about 99:1 to 70:30, more preferably in the range of about 98:2 to 85:15.

In a preferred embodiment, the process of the second aspect comprises a catalytic cracking step comprising contacting the solid biomass material with a catalytic cracking catalyst at a temperature of more than about 400° C. in a riser reactor to produce one or more cracked products and a spent catalytic cracking catalyst. The process also comprises a separation step of separating the one or more cracked products from the spent catalytic cracking catalyst, a regeneration step of regenerating spent catalytic cracking catalyst to produce a regenerated catalytic cracking catalyst, heat and carbon dioxide; and a recycling step of recycling the regenerated catalytic cracking catalyst to the catalytic cracking step.

The catalytic cracking step is preferably carried out as described herein before, where the solid biomass material is contacted with the catalytic cracking catalyst in the riser reactor. In the riser reactor any intermediate oil product and/or cracked products derived from the solid biomass material may be produced.

The separation step is preferably carried out with the help of one or more cyclone separators and/or one or more swirl tubes. The cyclone separators are preferably operated at a velocity in the range from about 18 to 80 meters/second, more preferably at a velocity in the range from about 25 to 55 meters/second.

In addition, the separation step may further comprise a stripping step. In such a stripping step the spent catalyst may be stripped to recover the products absorbed on the spent catalyst before the regeneration step. These products may be recycled and added to the cracked product stream obtained from the catalytic cracking step.

The regeneration step preferably comprises contacting the spent catalytic cracking catalyst with an oxygen containing gas in a regenerator at a temperature of equal to or more than about 550° C. to produce a regenerated catalytic cracking catalyst, heat and carbon dioxide. During the regeneration step, the coke that can be deposited on the catalyst as a result of the catalytic cracking reaction is burned off to restore the catalyst activity.

The oxygen containing gas may be any oxygen containing gas known to the skilled person to be suitable for use in a regenerator. For example the oxygen containing gas may be air or oxygen-enriched air. By oxygen enriched air is herein understood air comprising more than about 21 vol. % oxygen (O₂), more preferably air comprising equal to or more than about 22 vol. % oxygen, based on the total volume of air.

The heat produced in the exothermic regeneration step is preferably employed to provide energy for the endothermic catalytic cracking step. In addition the heat produced can be used to heat water and/or generate steam. The steam may be used elsewhere in the refinery, for example as a liftgas in the riser reactor.

In a preferred embodiment, the spent catalytic cracking catalyst is regenerated at a temperature in the range from equal to or more than about 575° C., more preferably from equal to or more than about 600° C., to equal to or less than about 950° C., more preferably to equal to or less than about 850° C. In another preferred embodiment, the spent catalytic cracking catalyst is regenerated at a pressure in the range from equal to or more than about 0.5 bar absolute to equal to or less than about 10 bar absolute (about 0.05 Mpa to about 1 MPa), more preferably from equal to or more than about 1.0 bar absolute to equal to or less than about 6 bar absolute (about 0.1 MPa to about 0.6 MPa).

The regenerated catalytic cracking catalyst can be recycled to the catalytic cracking step. In a preferred embodiment, a side stream of make-up catalyst is added to the recycle stream to make-up for loss of catalyst in the reaction zone and regenerator.

The one or more products produced according to the second aspect of the invention may subsequently be fractionated to produce one or more product fractions, which may in turn subsequently be hydrotreated (for example hydrodeoxygenated).

The one or more products produced by the process according to the second aspect of the invention can be used as an intermediate to prepare a biofuel and/or biochemical component. Such a process is simple and requires a minimum of processing steps to convert a solid biomass material to a biofuel component and/or biochemical component.

The biofuel and/or biochemical component(s) may advantageously be further converted to and/or blended with one or more further components into novel biofuels and/or biochemicals.

The process according to the invention therefore also provides a more direct route via conversion of solid biomass material to second generation, or advanced, biofuels and/or biochemicals.

According to a fourth aspect, there is provided a distributor for feeding a fluidised biomass stream into a riser reactor, the distributor comprising one or more delivery apertures having a diameter as defined anywhere hereinabove.

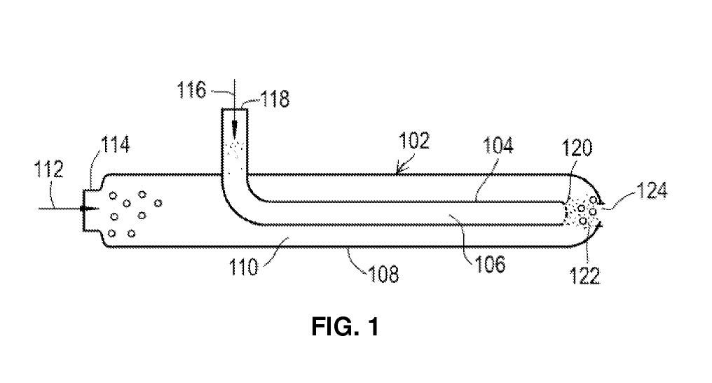

An embodiment of the invention is illustrated by FIG. 1. As shown in FIG. 1, feed nozzle 102 comprises cylindrical inner tube 104 defining fluid conduit 106 and outer tube 108 arranged around inner tube 104. The outer surface of inner tube 104 and the inner surface of outer tube 108 define annular conduit 110 to accompany solid biomass material 112. A stream of solid biomass material 112 is provided to annular conduit 110 via a first inlet 114. A fluid stream of steam 116 is provided to fluid conduit 106 via a second inlet 118. The fluid stream of steam 116 leaves fluid conduit 106 via fluid conduit outlet 120. Steam 116 is mixed with the stream of solid biomass material 112 to form fluidized biomass stream 122, which that leaves the feed nozzle via delivery aperture 124.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A process for converting a solid biomass material comprising the steps of:
a) mixing a solid biomass material with a fluid to form a fluidized biomass stream; and
b) propagating the fluidized biomass stream into a riser reactor via at least one delivery aperture;
wherein the solid biomass material has a particle size distribution with a mean particle size diameter, and wherein the delivery aperture has a diameter equal to or more than about three times the mean particle size diameter of the particle size distribution of the solid biomass material.

2. The process of claim 1, wherein the solid biomass material has a particle size distribution with a 99-vol % maximum particle size diameter, and the at least one delivery aperture has a diameter equal to or more than about three times said 99-vol % maximum particle size diameter.

3. The process of claim 1, wherein the fluid comprises a gas selected from the group consisting of steam, vaporized liquefied petroleum gas, gasoline, diesel, kerosene, naphtha, methane, hydrogen sulphide, hydrogen, and any combination thereof.

4. The process of claim 1 further comprising propagating the fluidised biomass stream into the riser reactor under a pressure in the range of from equal to or more than about 0.05 to equal to or less than about 0.5 MegaPascal.

5. The process of claim 1 further comprising propagating the fluidised biomass stream into the riser reactor at a velocity in the range from equal to or more than about 10 meter/second to equal to or less than about 100 meter/second.

6. The process of claim 1 wherein the at least one delivery aperture is located in a feed nozzle.

7. The process of claim 6 wherein the feed nozzle comprises an inner tube disposed in an outer tube, wherein the outer surface of the inner tube and the inner surface of the outer tube define an annular conduit to receive the solid biomass material, and wherein each of the tubes have an inlet end and an outlet end.

8. The process of claim 7 further comprising the step of mixing the fluid and the solid biomass material in the feed nozzle.

9. The process of claim 1 further comprising propagating the fluidized biomass stream into the riser reactor via a plurality of delivery apertures, each delivery aperture having a diameter equal to or more than about three times the mean particle size diameter of the particle size distribution of the solid biomass material.

10. The process of claim 9 wherein the plurality of delivery apertures is arranged in one or more arrays.

11. The process of claim 10, wherein the delivery apertures are arranged in one or more annular arrays.

12. The process of claim 11, wherein the fluidized biomass stream is propagated into the riser reactor via a plurality of annular and concentric arrays of delivery apertures.

13. The process of claim 1 wherein the at least one delivery aperture takes the form of a feed nozzle.

14. A process for converting a solid biomass material comprising:
feeding a solid biomass material into a riser reactor via at least one delivery aperture;
wherein the solid biomass material has a particle size distribution with a mean particle size diameter, and wherein the delivery aperture has a diameter equal to or more than three times the mean particle size diameter of the particle size distribution of the solid biomass material; and
contacting the solid biomass material with a catalytic cracking catalyst at a temperature of equal to or more than about 400° C. in the riser reactor to produce one or more products.

15. The process of claim 14 wherein the contacting step further comprises contacting the solid biomass material and a hydrocarbon-cofeed with the catalytic cracking catalyst.

16. The process of claim 14, wherein the solid biomass material has a particle size distribution with a 99-vol % maximum particle size diameter, and wherein the delivery aperture has a diameter equal to or more than about three times this 99-vol % maximum particle size diameter.

17. A method for configuring an existing fluidized catalytic cracking unit comprising a riser reactor to convert a solid biomass material, the method comprising:
replacing one or more existing feedstock distributors comprising delivery apertures having a first diameter with one or more new feedstock distributors comprising delivery apertures having a second diameter,
wherein the second diameter is larger than the first diameter and wherein the second diameter is equal to or more than three times the mean particle size diameter of the particle size distribution of a solid biomass material to be fed into the one or more new feedstock distributors.

18. The process of claim 17, wherein the solid biomass material has a particle size distribution with a 99-vol % maximum particle size diameter, and wherein the second diameter is equal to or more than three times this 99-vol % maximum particle size diameter.
